(19) United States
(12) Patent Application Publication
(10) Pub. No.: US 2026/0302691 A1
(43) Pub. Date: Oct. 1, 2026

(54) ELECTRICAL CONNECTOR ASSEMBLY

(71) Applicant: Molex, LLC, Lisle, IL (US)

(72) Inventor: De-Qian Lu, Shanghai (CN)

(21) Appl. No.: 19/575,936

(22) Filed: Mar. 24, 2026

(30) Foreign Application Priority Data
Mar. 26, 2025 (CN) 202510367212.1

(51) Int. Cl. H01R 13/627; H01R 4/18; H01R 13/64

(52) U.S. Cl. CPC H01R 13/6271; H01R 4/18; H01R 13/64

(57) ABSTRACT

An electrical connector assembly includes: a first electrical connector, the first electrical connector includes a first housing, a second housing which surrounds an outer side of one end of the first housing, and a plurality of first conductive terminals which are positioned in an interior of the first housing and the second housing, an outer side surface of one end of the second housing close to the first housing has a locking structure which is in form of protrusion; a second electrical connector, the second electrical connector includes a third housing and a plurality of second conductive terminals which are positioned in an interior of the third housing, an inner side surface of the third housing has an engaging structure which is in form of recessed groove; in a state that the first electrical connector and the second electrical connector are mated with each other, the second housing is partially inserted into the interior of the third housing, the locking structure resiliently snap-fit with the engaging structure, the plurality of first conductive terminals and the plurality of second conductive terminals are electrically connected correspondingly. An overall size of the electrical connector assembly is reduced, and diversity of application scenarios of the electrical connector assembly is increased.

### TECHNICAL FIELD

The present disclosure relates to the field of electrical connectors, and specifically relates to an electrical connector assembly.

### BACKGROUND

An electrical connector assembly is a key element which is used to transmit electrical signal and electrical power between electronic devices, a basic function of the electrical connector assembly includes realization of circuit connection, signal transmission and mechanical fixing. The electrical connector assembly generally is composed of two electrical connectors (that is, joints). The electrical connector assembly realizes electrical signal transmission and electrical power transmission through the mating of the two electrical connectors. In the existing electrical connector assembly in prior art, the two electrical connectors realize retention therebetween generally through a latch structure. For example, a latching claw is provided on an outer surface of an electrical connector housing, a corresponding protruding block is provided on an outer surface of a mating electrical connector housing, the latching claw and the protruding block cooperate with each other to realize retention of the two electrical connectors after mating. However, such a retention structure increases the overall size of the electrical connector assembly, which is not beneficial to miniaturization of the electrical connector assembly, and limits application scenarios of the electrical connector assembly.

### SUMMARY

In view of the above, the present disclosure provides an electrical connector assembly to at least solve a problem that an overall size is increased after an electrical connector assembly in prior art is provided with a latch structure.

An embodiment of the present disclosure provides an electrical connector assembly, comprising: a first electrical connector, the first electrical connector comprises a first housing, a second housing which surrounds an outer side of one end of the first housing, and a plurality of first conductive terminals which are positioned in an interior of the first housing and the second housing, an outer side surface of one end of the second housing close to the first housing has a locking structure which is in form of protrusion; a second electrical connector, the second electrical connector comprises a third housing and a plurality of second conductive terminals which are positioned in an interior of the third housing, an inner side surface of the third housing has an engaging structure which is in form of recessed groove; in a state that the first electrical connector and the second electrical connector are mated with each other, the second housing is partially inserted into the interior of the third housing, the locking structure resiliently snap-fits with the engaging structure, the plurality of first conductive terminals and the plurality of second conductive terminals are electrically connected correspondingly.

In some embodiments, an elasticity of the second housing is higher than an elasticity of the third housing; the locking structure has a compressed state during a snap-fit engagement process between the locking structure and the engaging structure and a rebound state when the snap-fit engagement between the locking structure and the engaging structure is completed, thereby providing an operator with a tactile snap-fit sensation.

In some embodiments, the locking structure is a conical annular protrusion which encircles the outer side surface of the second housing, the engaging structure is a conical annular recessed groove which encircles the inner side surface of the third housing.

In some embodiments, along a direction away from the first housing, the locking structure sequentially comprises a first inclined surface which is inclined toward an outer side of the second housing and an extending surface; along a direction away from a mating surface of the second electrical connector, the engaging structure sequentially comprises a guiding surface, a second inclined surface which is inclined toward an outer side of the third housing, and a third inclined surface which is inclined toward an inner side of the third housing; the first inclined surface and the extending surface therebetween form the conical protrusion which is inserted into the engaging structure, the second inclined surface and the third inclined surface therebetween form the conical recessed groove which receives the locking structure.

In some embodiments, an angle of the conical protrusion is less than or equal to an angle of the conical recessed groove.

In some embodiments, the first inclined surface and the extending surface of the locking structure therebetween further comprise a rounding surface which is arc, the rounding surface contacts the conical recessed groove of the engaging structure.

In some embodiments, the extending surface is perpendicular to a mating direction that the first electrical connector is inserted into the second electrical connector.

In some embodiments, an inner diameter of the third housing at the guiding surface is gradually decreased along a direction that the guiding surface is close to the second inclined surface, the guiding surface and the second inclined surface therebetween form a conical protruding portion, the conical protruding portion and the conical recessed groove of the engaging structure together cooperate with each other to latch with the locking structure.

In some embodiments, an outer wall of the first housing has at least one first fool-proof portion, an inner wall of the third housing has at least one second fool-proof portion, in a state that the plurality of first conductive terminals and the plurality of second conductive terminals are electrically connected, the first fool-proof portion and the second fool-proof portion match each other.

In some embodiments, an outer wall of the second housing has a first mount guiding structure, an outer wall of the third housing has a second mount guiding structure, in a state that the plurality of first conductive terminals and the plurality of second conductive terminals are electrically connected, the first mount guiding structure and the second mount guiding structure are aligned with each other.

In some embodiments, tail portions of the plurality of second conductive terminals are arranged as a regular polygon.

In some embodiments, the electrical connector assembly further comprises: a first conductive wire group, the first conductive wire group comprises at least one first conductive wire, the first conductive wire comprises a first conductor and a first insulative layer which enwraps the first conductor; each first conductive terminal has a first two-segment type crimping portion which is crimped with the corresponding first conductive wire, wherein a first segment of the first two-segment type crimping portion is crimped with the first conductor, a second segment of the first two-segment type crimping portion is crimped with the first insulative layer.

In some embodiments, the electrical connector assembly further comprises: a second conductive wire group, the second conductive wire group comprises at least one second conductive wire, the second conductive wire comprises a second conductor and a second insulative layer which enwraps the second conductor; each second conductive terminal has a second two-segment type crimping portion which is crimped with the corresponding second conductive wire, wherein a first segment of the second two-segment type crimping portion is crimped with the second conductor, a second segment of the second two-segment type crimping portion is crimped with the second insulative layer.

In some embodiments, a side wall of the first segment of the first two-segment type crimping portion has an inspection hole which penetrates the side wall; and/or a side wall of the first segment of the second two-segment type crimping portion has an inspection hole which penetrates the side wall.

In some embodiments, the first housing has a bottom surface, is provided with a terminal connecting cavity from the bottom surface, the terminal connecting cavity is used to receive the first conductive terminal, a side wall of the terminal connecting cavity has an opening; and/or the third housing has a rear surface, is provided with a terminal connecting cavity from the rear surface, the terminal connecting cavity is used to receive the second conductive terminal, a side wall of the terminal connecting cavity has an opening.

In some embodiments, one end of the first conductive terminal close to the bottom surface is positioned in the interior of the first housing and is not coplanar with the bottom surface; and/or one end of the second conductive terminal close to the rear surface is positioned in the interior of the third housing and is not coplanar with the rear surface.

In comparison with the prior art, the present disclosure embodiment provided by electrical connector assembly at least realizes the follow beneficial effects: in the electrical connector assembly of the present disclosure, in a state the first electrical connector and the second electrical connector are mated with each other, the locking structure which is provided on the outer side surface of the one end of the second housing close to the first housing and is in form of protrusion and the engaging structure which is provided on the inner side surface of the third housing and is in form of recessed groove cooperate with each other in elastic latching, the locking structure of the first electrical connector may be received in the interior of the second electrical connector, in comparison with the latch structure provided on the outer surface of the electrical connector assembly in prior art, an overall size of the electrical connector assembly of the present disclosure is reduced, the electrical connectors which are small in dimension are realized in the present disclosure, diversity of application scenarios of the electrical connector assembly of the present disclosure is increased.

### BRIEF DESCRIPTION OF THE DRAWINGS

The accompanying drawings is incorporated into the specification and constitutes a part of the specification, illustrates embodiments which conform to the present disclosure, and is used together with the specification to explain the principles of the present disclosure. It is apparent that the figures described below are only some embodiments of the present disclosure. For those skilled in the art, other figures also may be obtained based on these figures without inventive effort.

FIG. 1 is a perspective view of a mating state of an electrical connector assembly provided by the present disclosure;

FIG. 2 is an exploded view of a first electrical connector provided by the present disclosure;

FIG. 3 is a perspective view of the first electrical connector provided by the present disclosure;

FIG. 4 is a front view of the first electrical connector of FIG. 3;

FIG. 5 is an enlarged view of a region A of FIG. 4;

FIG. 6 is an exploded view of a second electrical connector provided by the present disclosure;

FIG. 7 is a perspective view of the second electrical connector provided by the present disclosure;

FIG. 8 is a front view of the mating state of the electrical connector assembly of FIG. 1;

FIG. 9 is a schematic cross-sectional view taken along a line C-C of FIG. 8;

FIG. 10 is an enlarged view of a region B of FIG. 9;

FIG. 11 is a perspective view of the second electrical connector of FIG. 7 from another angle;

FIG. 12 is a perspective view of the second electrical connector of FIG. 7 from still another angle;

FIG. 13 is a right view of the second electrical connector of FIG. 7;

FIG. 14 is a left view of the second electrical connector of FIG. 7;

FIG. 15 is an exploded view of an another first electrical connector provided by the present disclosure;

FIG. 16 is a perspective view of the another first electrical connector provided by the present disclosure, where a second housing and a sealing ring are omitted;

FIG. 17 is a perspective view of the another first electrical connector provided by the present disclosure;

FIG. 18 is a perspective view of the another first electrical connector provided by the present disclosure from another angle;

FIG. 19 is a perspective view of a first conductive terminal of FIG. 17;

FIG. 20 is a front view of a first housing, the first conductive terminals and first conductive wires of FIG. 17 which are cooperatively connected;

FIG. 21 is a schematic cross-sectional view taken along a line G-G of FIG. 20;

FIG. 22 is an enlarged view of a region H of FIG. 21;

FIG. 23 is an exploded view of an another second electrical connector provided by the present disclosure;

FIG. 24 is a perspective view of the another second electrical connector provided by the present disclosure;

FIG. 25 is a right view of the another second electrical connector provided by the present disclosure;

FIG. 26 is a structure schematic view of the first housing of FIG. 17;

FIG. 27 is a structure schematic view of a third housing of FIG. 24; and

FIG. 28 is a perspective view of the another first electrical connector of FIG. 17, where the second housing and a fourth housing are omitted.

Reference numerals are presented as follows.
100 first electrical connector
110 first housing
111 first fool-proof portion
111a first sub fool-proof portion
111b second sub fool-proof portion
112 bottom surface
120 second housing
121 first mount guiding structure
130 first conductive terminal
131 first two-segment type crimping portion
140 locking structure
141 first inclined surface
142 extending surface
143 rounding surface
150 fourth housing
160 sealing ring
200 second electrical connector
210 third housing
211 second fool-proof portion
211a third sub fool-proof portion
211b fourth sub fool-proof portion
212 second mount guiding structure
213 rear surface
220 second conductive terminal
221 tail portion
222 second two-segment type crimping portion
230 engaging structure
231 guiding surface
232 second inclined surface
233 third inclined surface
240 fifth housing
250 sixth housing
260 seal ring
270 mating surface
280 positioning post
400 first conductive wire group
410 first conductive wire
411 first conductor
412 first insulative layer
500 second conductive wire group
510 second conductive wire
511 second conductor
512 second insulative layer
600 inspection hole
700 terminal connecting cavity
710 opening

### DETAILED DESCRIPTION

The example implementations will now be described more comprehensively with reference to the accompanying drawings. However, the example implementations can be implemented in various forms and should not be understood as limited to the implementations described herein. On the contrary, providing these implementations makes the present disclosure comprehensive and complete, and fully conveys the concept of the example implementations to those skilled in the art. The same reference numerals in the figure indicate the same or similar structures, so repeated descriptions thereof will be omitted.

The use of “first”, “second”, and similar words in specific descriptions does not indicate any order, quantity, or importance, but is only used to distinguish different components. In addition, in the description of the present disclosure, orientation or positional relationships indicated by the terms “up”, “down”, etc. are based on the orientation or positional relationships shown in the accompanying drawings, which are only for ease of description and do not indicate or imply that the device or component referred to must have a specific orientation, be constructed and operated in a specific orientation, and therefore cannot be understood as a limitation of the present disclosure.

It should be noted that embodiments and features of different embodiments of the present disclosure may be combined with each other without conflict.

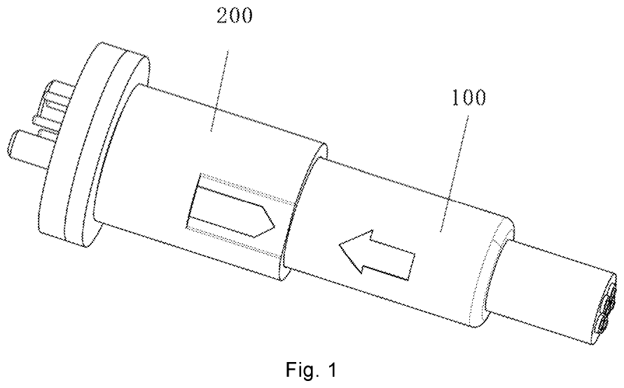

As shown in FIG. 1, an embodiment of the present disclosure provides an electrical connector assembly which includes a first electrical connector 100 and a second electrical connector 200.

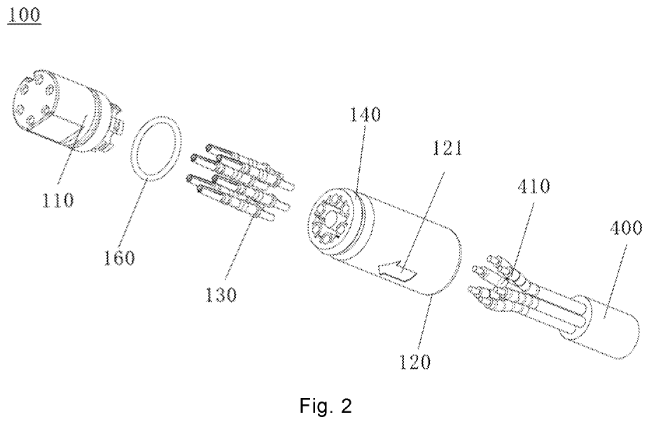

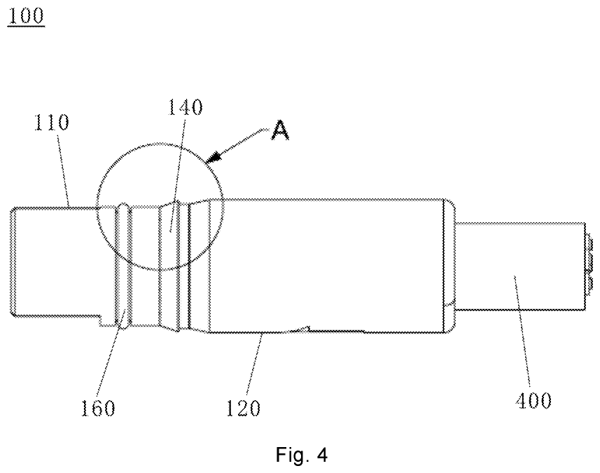

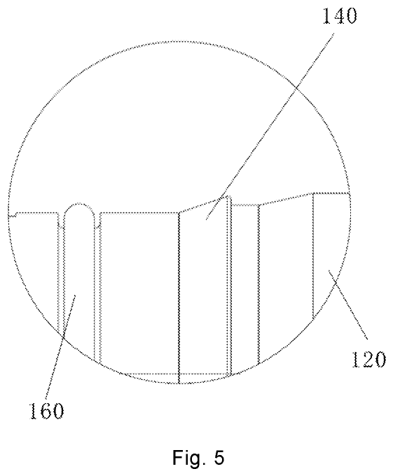

As shown in FIG. 2 to FIG. 5, the first electrical connector 100 includes a first housing 110, a second housing 120 which surrounds an outer side of one end of the first housing 110, and a plurality of first conductive terminals 130 which are positioned in an interior of the first housing 110 and the second housing 120. An outer side surface of one end of the second housing 120 close to the first housing 110 has a locking structure 140 in form of protrusion.

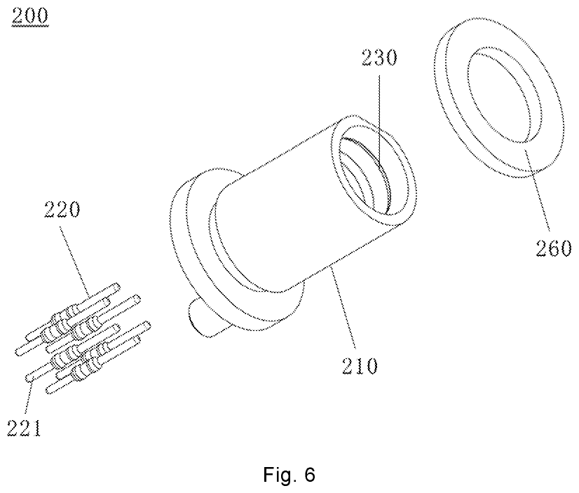

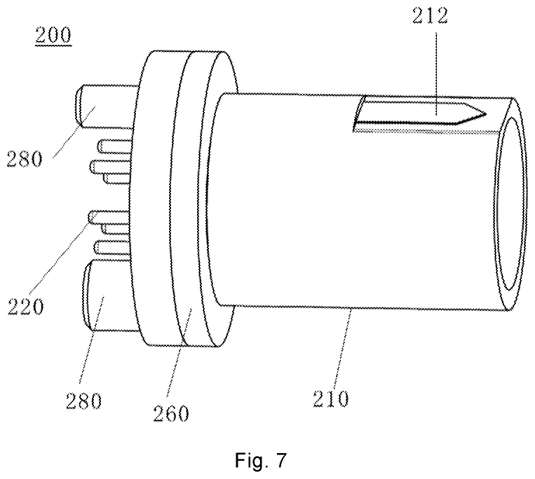

As shown in FIG. 6 and FIG. 7, the second electrical connector 200 includes a third housing 210, and a plurality of second conductive terminals 220 which are positioned in an interior of the third housing 210. An inner side surface of the third housing 210 has an engaging structure 230 in form of recessed groove.

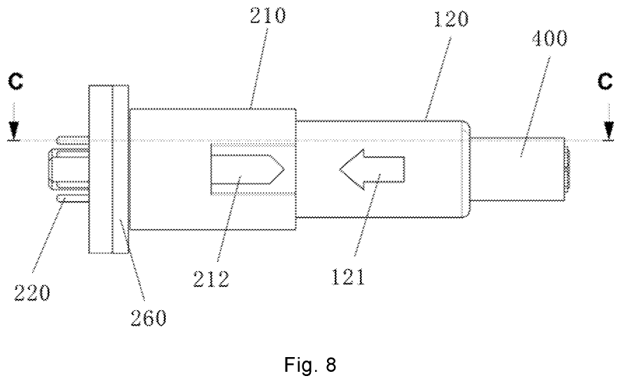

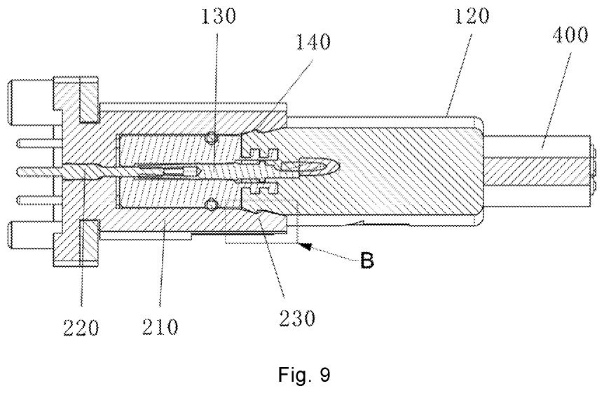

As shown in FIG. 8 to FIG. 10, in a state the first electrical connector 100 and the second electrical connector 200 are mated with each other, the second housing 120 is partially inserted into the interior of the third housing 210, the locking structure 140 resiliently snap-fits with the engaging structure 230, the plurality of first conductive terminals 130 and the plurality of second conductive terminals 220 are electrically connected correspondingly.

In the present embodiment, in a state that the first electrical connector 100 and the second electrical connector 200 are mated with each other, the locking structure 140 which is provided on the outer side surface of the one end of the second housing 120 close to the first housing 110 and is in form of protrusion and the engaging structure 230 which is provided on the inner side surface of the third housing 210 and is in form of recessed groove cooperate with each other in elastic latching, the locking structure 140 of the first electrical connector 100 may be received in the interior of the second electrical connector 200, in comparison with a latch structure provided on an outer surface of an electrical connector assembly in prior art, an overall size of the electrical connector assembly of the present disclosure is reduced, the electrical connectors which are small in dimension are realized in the present disclosure, diversity of application scenarios of the electrical connector assembly of the present disclosure is increased. At the same time, the present embodiment is capable of making the electrical connector assembly form a locking effect after mating, be not prone to become disengaged, and have a better retention force. Moreover, during the unmating process of the first electrical connector 100 and the second electrical connector 200, because of the cooperation between the locking structure 140 and the engaging structure 230, a withdrawal force will be gradually increased, which may effectively prevent the electrical connector assembly from becoming disengaged in circumstances, such as vibration or mechanical impact and the like, this principle will be described later. In addition, during the mating process of the first electrical connector 100 and the second electrical connector 200, because of cooperation between the protrusion of the locking structure 140 and the recessed groove of the engaging structure 230, when the mating is performed by an operator, a “click” sensation in inserting can be felted, a use experience of the operator is promoted.

In some embodiments, both the first conductive terminal 130 and the second conductive terminal 220 may be integrally formed.

In some embodiments, an elasticity of the second housing 120 is higher than an elasticity of the third housing 210. That is, the locking structure 140 may be elastically deformed when subjected to an external force, and the locking structure 140 is restored to an original state thereof once the external force is removed. The locking structure 140 has a compressed state during a snap-fit engagement process between the locking structure 140 and the engaging structure 230 and a rebound state when the snap-fitting engagement between the locking structure 140 and the engaging structure 230 is completed, thereby providing the operator with a tactile snap-fit sensation. Specifically, in elasticity of materials of the first housing 110, the second housing 120 and the third housing 210, the elasticity of the second housing 120 is the highest, the elasticity of the first housing 110 and the elasticity of the third housing 210 may be the same or different. In the process that the first electrical connector 100 and the second electrical connector 200 are mated with each other, the first housing 110 does not take part in deformation, the locking structure 140 of the second housing 120 in form of protrusion will be compressed to generate main deformation, whether deformation of the third housing 210 occurs depends on the material to be selected and a thickness of the third housing 210, if the material of the third housing 210 is too hard, the third housing 210 nearly does not take part in deformation; if the material of the third housing 210 has excellent toughness, some corresponding deformation of the third housing 210 will passively occur in a process that the second housing 120 is inserted into the third housing 210. In some embodiments, both the first housing 110 and the third housing 210 may be an ordinary engineering plastic, the second housing 120 may be a high-elasticity plastic (an elastomer). In the process that the first electrical connector 100 and the second electrical connector 200 are mated with each other, the second housing 120 which is the high-elasticity plastic provides capability of elastic deformation, in cooperation with the first housing 110 and the third housing 210 which are the ordinary engineering plastic, the “click” sensation in mating is further promoted. In other embodiments, when selecting the materials of the first housing 110, the second housing 120 and the third housing 210, it should be satisfied that the elasticity of the second housing 120 is higher than the elasticity of the third housing 210, so that the locking structure 140 is capable of resiliently snap-fitting with the engaging structure 230. Selectively, the elasticity of the material of the second housing 120 is much higher than the elasticity of the material of the third housing 210, for example, the second housing 120 is a high-elasticity plastic, the third housing 210 is an ordinary engineering plastic, when the mating between the first electrical connector 100 and the second electrical connector 200 is completed, the snap-fitting engagement between the locking structure 140 and the engaging structure 230, combined with the superior rebound characteristics of the second housing 120, an enhanced tactile snap-fit sensation is provided.

Continuously referring to FIG. 2 to FIG. 4 and FIG. 6, in some embodiments, the locking structure 140 is a conical annular protrusion which encircles the outer side surface of the second housing 120, and the engaging structure 230 is a conical annular recessed groove which encircles the inner side surface of the third housing 210. In the present embodiment, the provision of the annular protrusion and the annular recessed groove may make forces subjected at various circumferential positions of the second housing 120 and the third housing 210 uniform in processes that the first electrical connector 100 is inserted into and withdrawn from the second electrical connector 200, avoid the first electrical connector 100 and the second electrical connector 200 being damaged after insertion and withdrawal are performed many times.

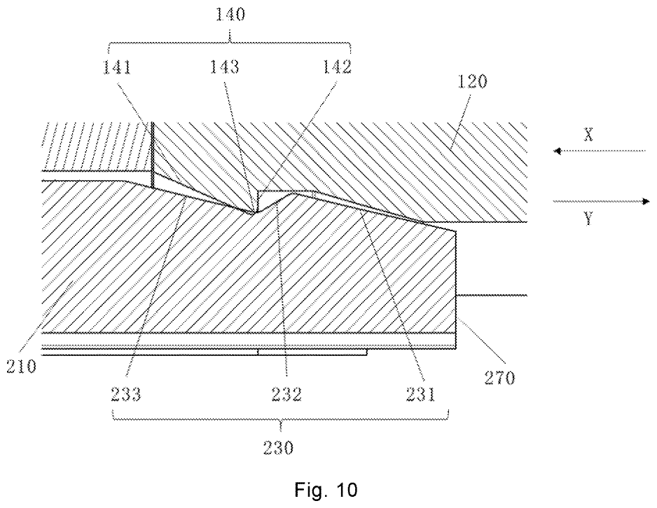

As shown in FIG. 10, in some embodiments, along a direction away from the first housing 110, the locking structure 140 sequentially includes a first inclined surface 141 which is inclined toward an outer side of the second housing 120, and an extending surface 142. Along a direction away from a the mating surface 270 of the second electrical connector 200, the engaging structure 230 sequentially includes a guiding surface 231, a second inclined surface 232 which is inclined toward an outer side of the third housing 210, and a third inclined surface 233 which is inclined toward an inner side of the third housing 210. The first inclined surface 141 and the extending surface 142 therebetween form the conical protrusion which is inserted into the engaging structure 230, and the second inclined surface 232 and the third inclined surface 233 therebetween form the conical recessed groove which receives the locking structure 140. In the present embodiment, the design of the first inclined surface 141, the extending surface 142, guiding surface 231, the second inclined surface 232 and the third inclined surface 233 facilitates forced demolding of the locking structure 140 and the engaging structure 230 during mold manufacturing, thereby improving the manufacturability of the locking structure 140 and the engaging structure 230; the cooperation between the conical protrusion and the conical recessed groove as described above may improve the retention force between the first electrical connector 100 and the second electrical connector 200 after the first electrical connector 100 and the second electrical connector 200 are mated with each other.

Continuously referring to FIG. 10, in some embodiments, an angle of the conical protrusion is less than or equal to an angle of the conical recessed groove. The provision of the present embodiment as described above may make the locking structure 140 completely inserted into the engaging structure 230, enabling the locking structure 140 and the engaging structure 230 to achieve an resiliently snap=fitting engagement to the greatest extent, thereby further enhancing the “click” sensation during mating.

Continuously referring to FIG. 10, in some embodiments, the first inclined surface 141 and the extending surface 142 of the locking structure 140 therebetween further include a rounding surface 143 which is arc, the rounding surface 143 contacts the conical recessed groove of the engaging structure 230. The rounding surface 143 is a small rounded corner at a top end of the conical protrusion of the locking structure 140. If it is a sharp corner at the top end of the conical protrusion, after insertion and withdrawal are performed many times, the sharp corner is easily worn away, and the locking structure 140 which is worn away may affect cooperation between the locking structure 140 and the engaging structure 230. The provision of the rounding surface 143 may lower possibility that the locking structure 140 is damaged after insertion and withdrawal of the electrical connector assembly are performed many times, and insertion and withdrawal durability of the locking structure 140 is promoted.

Continuously referring to FIG. 10, in some embodiments, the extending surface 142 is perpendicular to a mating direction that the first electrical connector 100 is inserted into the second electrical connector 200. The provision of the extending surface 142 of the present embodiment as described above may make that the conical protrusion of the locking structure 140 which has been subjected to be compressed is capable of rebounding immediately when the second housing 120 and the third housing 210 are mated with each other, in turn the “click” sensation in inserting for the operator is promoted.

Continuously referring to FIG. 10, in some embodiments, an inner diameter of the third housing 210 at the guiding surface 231 is gradually decreased along a direction that the guiding surface 231 is close to the second inclined surface 232, the guiding surface 231 and the second inclined surface 232 therebetween form a conical protruding portion, the conical protruding portion and the conical recessed groove of the engaging structure 230 together cooperate with each other to latch with the locking structure 140. In the present embodiment, when the second housing 120 and the third housing 210 are mated with each other (in an X direction of FIG. 10, that is, in an inserting direction of the second housing 120 relative to the third housing 210), when the conical protrusion of the locking structure 140 and the conical protruding portion of the engaging structure 230 coincide with each other, an insertion force or a withdrawal force is maximum, once the conical protrusion of the locking structure 140 passes over the conical protruding portion of the engaging structure 230, the “click” sensation in inserting for mating may be obtained; the cooperation between the conical protrusion of the locking structure 140 and the conical protruding portion and the conical recessed groove of the engaging structure 230 as described above may improve the retention force between the first electrical connector 100 and the second electrical connector 200 after the first electrical connector 100 and the second electrical connector 200 are mated with each other.

Continuously referring to FIG. 10, in some embodiments, during the unmating process of the first electrical connector 100 and the second electrical connector 200 (in a Y direction of FIG. 10, that is, in a withdrawing direction of the second housing 120 relative to the third housing 210), the closer the second inclined surface 232 is to the mating surface 270 in the Y direction, the smaller the inner diameter of the third housing 210 is, and thus the greater the withdrawal force required, which may effectively prevent the electrical connector assembly from becoming disengaged in circumstances, such as vibration or mechanical impact and the like.

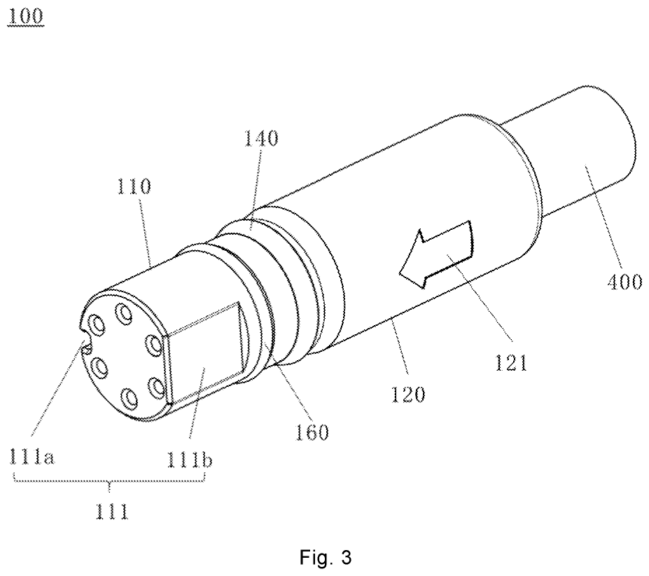

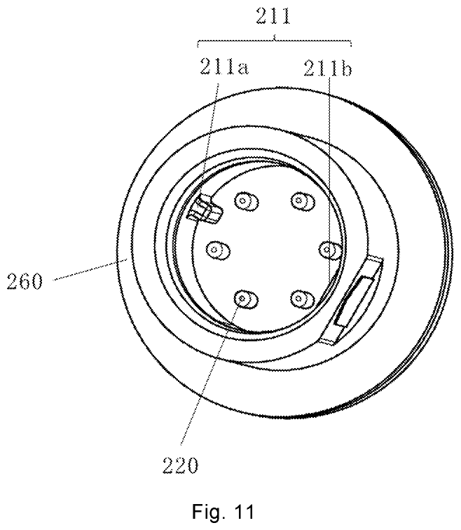

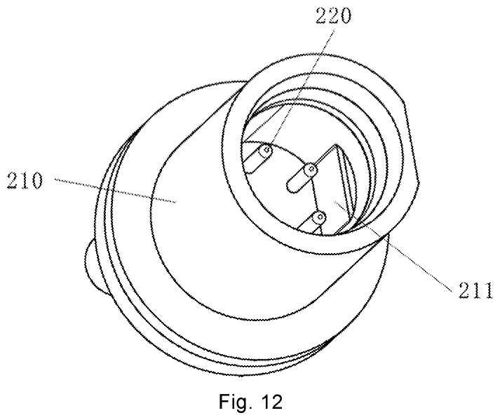

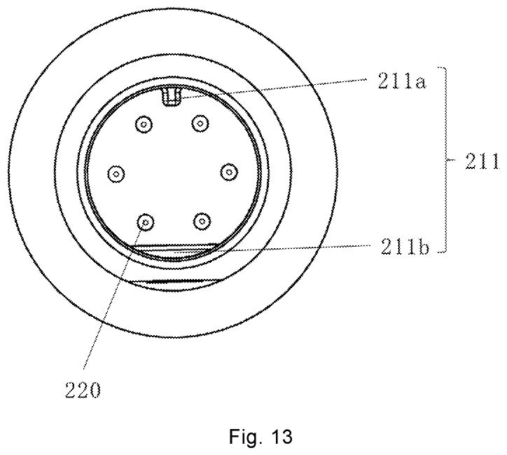

As shown in FIG. 3 and FIG. 11 to FIG. 13, in some embodiments, an outer wall of the first housing 110 has at least one first fool-proof portion 111, an inner wall of the third housing 210 has at least one corresponding second fool-proof portion 211, when the first electrical connector 100 and the second electrical connector 200 are mated with each other, the first fool-proof portion 111 and the corresponding second fool-proof portion 211 match each other. The number and structure of the first fool-proof portion 111 are provided according to practical situation, and are not specifically limited herein. In some embodiments, the outer wall of the first housing 110 may only have one first fool-proof portion 111, the inner wall of the third housing 210 has one corresponding second fool-proof portion 211. In other embodiments, the first housing 110 may have two different first fool-proof portions 111, specifically, a first sub fool-proof portion 111a and a second sub fool-proof portion 111b. Correspondingly, the third housing 210 may have two different second fool-proof portions 211, specifically, a third sub fool-proof portion 211a and a fourth sub fool-proof portion 211b. Wherein, the first sub fool-proof portion 111a and the third sub fool-proof portion 211a match each other; the second sub fool-proof portion 111b and the fourth sub fool-proof portion 211b match each other. In still some embodiments, the outer wall of the first housing 110 may have three first fool-proof portions 111, the inner wall of the third housing 210 has three corresponding second fool-proof portions 211, the three first fool-proof portions 111 are not specifically limited in structures herein, the three first fool-proof portions 111 may be the same, two of the three first fool-proof portions 111 may be the same and the remaining one of the three first fool-proof portions 111 is different from the two of the three first fool-proof portions 111, or the three first fool-proof portions 111 are different from each other, which can be provided according to practical situation. The first fool-proof portion 111 and the second fool-proof portion 211 of the present embodiment may realize a fool-proof effect when the first housing 110 and the third housing 210 are mated with each other, wrongly mating is avoided, mating efficiency is improved; at the same time cooperation between the first fool-proof portion 111 and the second fool-proof portion 211 which have certain structures (for example, the first sub fool-proof portion 111a and the third sub fool-proof portion 211a) also may function as guiding.

Continuously referring to FIG. 2, FIG. 3, FIG. 7 and FIG. 8, in some embodiments, an outer wall of the second housing 120 has a first mount guiding structure 121, an outer wall of the third housing 210 has a second mount guiding structure 212, in a state that the plurality of first conductive terminal 130 and the plurality of second conductive terminal 220 are electrically connected, the first mount guiding structure 121 and the second mount guiding structure 212 are aligned with each other. Specifically, the first mount guiding structure 121 and the second mount guiding structure 212 each may be a mark which has an indicating function, such as an arrow or a marking point and the like. The first mount guiding structure 121 and the second mount guiding structure 212 of the present embodiment may improve mating efficiency of the operator when the first electrical connector 100 and the second electrical connector 200 are mated with each other.

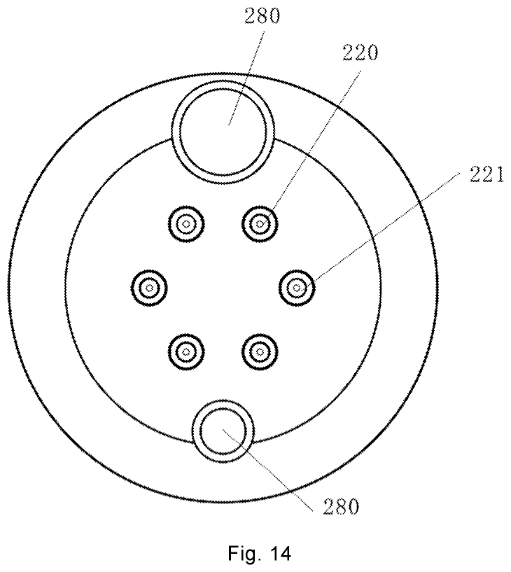

As shown in FIG. 14, in some embodiments, tail portions 221 of the plurality of second conductive terminals 220 are arranged as a regular polygon. Specifically, one end of the second conductive terminal 220 is a contacting portion, the other end of the second conductive terminal 220 is the tail portion 221, the tail portion 221 also may be referred to as a soldering portion or a crimping portion, the tail portion 221 may be directly soldered on a printed circuit board, also may be soldered to a cable or a conductive wire, also may be crimped with a cable, which can be provided according to practical situation, so the present disclosure is not limited to thereto. In the present embodiment, a contacting portion of the first conductive terminal 130 and the contacting portion of the second conductive terminal 220 are electrically connected, and the tail portion 221 of the second conductive terminal 220 is soldered on the printed circuit board. Further, in the present embodiment, the second conductive terminal 220 does not have any bend, so the tail portions 221 of the plurality of the second conductive terminals 220 on the printed circuit board may be arranged as a regular polygon. In other embodiments, if the second conductive terminal 220 bends at the contacting portion away from the tail portion 221, the arrangement of the contacting portions of the plurality of the second conductive terminals 220 may be different from the arrangement of the tail portions 221 of the plurality of the second conductive terminals 220, which may be adjusted according to practical situation, so the present disclosure is not limited to thereto.

The tail portion of the first conductive terminal 130 may be connected to an external device by various manners, for example, the tail portion of the first conductive terminal 130 is soldered to a cable or a conductive wire, or is crimped with a cable or a conductive wire, is soldered on a printed circuit board, and so on, so the present disclosure is not limited to thereto. Similarly, the tail portion 221 of the second conductive terminal 220 also may be connected to an external device by various manners, which may be selected according to practical situation. The manner of the tail portion of the first conductive terminal 130 connected to the external device may be the same as the manner of the tail portion 221 of the second conductive terminal 220 connected to the external device, the manner of the tail portion of the first conductive terminal 130 connected to the external device may not be the same as the manner of the tail portion 221 of the second conductive terminal 220 connected to the external device, which is selected according to practical situation.

Continuously referring to FIG. 7, in some embodiments, a side of the second electrical connector 200 close to the tail portion 221 of the second conductive terminal 220 has at least one positioning post 280. The positioning post 280 is used to function as positioning when the second electrical connector 200 is mounted to the external device (for example the printed circuit board). When the second electrical connector 200 has at least two positioning posts 280 and the at least two the positioning post 280 are not the same in size and/or position, the at least two positioning posts 280 further may function as fool-proof.

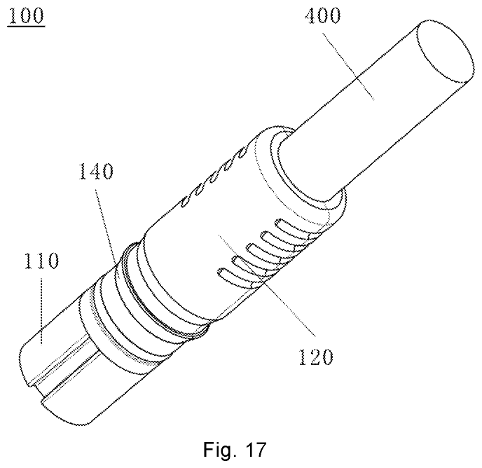

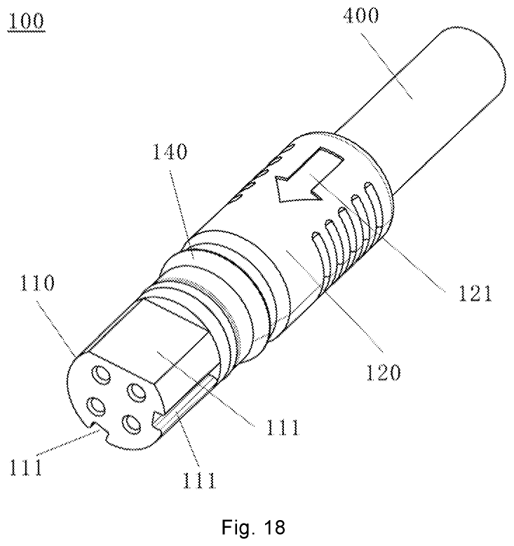

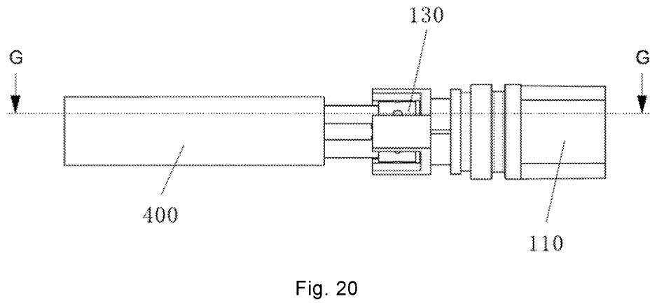

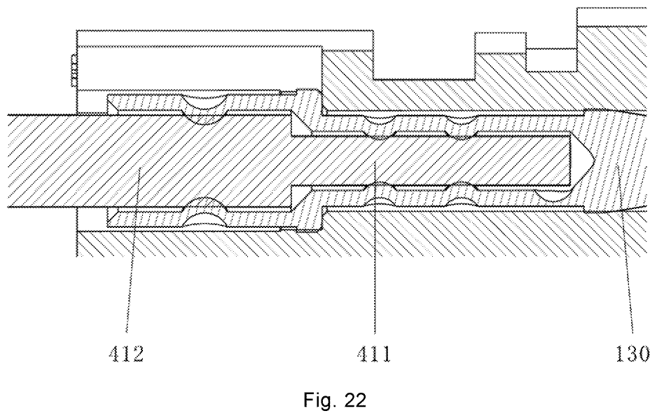

As shown in FIG. 2 to FIG. 4, FIG. 8 and FIG. 9 and FIG. 15 to FIG. 22, in some embodiments, the electrical connector assembly further includes a first conductive wire group 400. The first conductive wire group 400 includes at least one first conductive wire 410. The first conductive wire 410 includes a first conductor 411 and a first insulative layer 412 which enwraps the first conductor 411. The tail portion of each first conductive terminal 130 is a first two-segment type crimping portion 131 which is crimped with the corresponding first conductive wire 410, wherein, a first segment of the first two-segment type crimping portion 131 is crimped with the first conductor 411, a second segment of the first two-segment type crimping portion 131 is crimped with the first insulative layer 412. An inner diameter of the first segment of the first two-segment type crimping portion 131 is less than an inner diameter of the second segment of the first segment of the first two-segment type crimping portion 131. Wherein, “crimped with” here refers to that, a force is applied from outer surfaces of the first segment and the second segment of the first two-segment type crimping portion 131 of the first conductive terminal 130 toward inner surfaces of the first segment and the second segment of the first two-segment type crimping portion 131 of the first conductive terminal 130, so that the outer surfaces are depressed inwardly to retain the first conductor 411 and the first insulative layer 412 therein. In the present embodiment, the contacting portion of the first conductive terminal 130 and the contacting portion of the second conductive terminal 220 are electrically connected, and the tail portion of the first conductive terminal 130 is crimped with the first conductive wire 410.

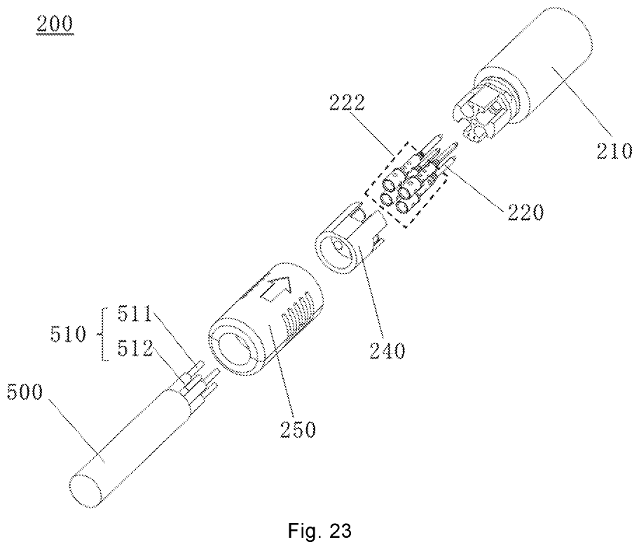

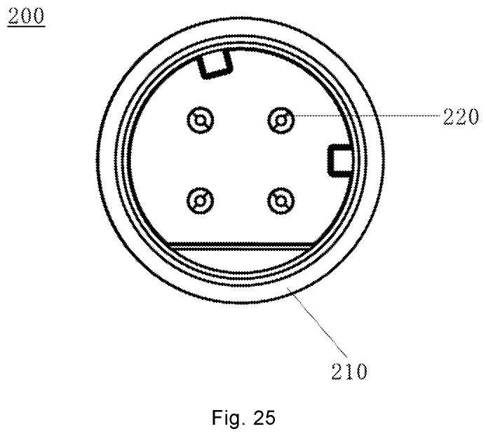

As shown in FIG. 23 to FIG. 25, in some embodiments, the electrical connector assembly further includes a second conductive wire group 500. The second conductive wire group 500 includes at least one second conductive wire 510. The second conductive wire 510 includes a second conductor 511 and a second insulative layer 512 which enwraps the second conductor 511. Wherein, a connecting manner (not shown) between the second conductive wire group 500 and the second conductive terminal 220 may be referred to the connecting manner between the first conductive wire group 400 and the first conductive terminal 130. Specifically, the tail portion 221 of each second conductive terminal 220 is a second two-segment type crimping portion 222 which is crimped with the corresponding second conductive wire 510, wherein, a first segment of the second two-segment type crimping portion 222 is crimped with the second conductor 511, a second segment of the second two-segment type crimping portion 222 is crimped with the second insulative layer 512. An inner diameter of the first segment of the second two-segment type crimping portion 222 is less than an inner diameter of the second segment of the second two-segment type crimping portion 222. Wherein, “crimped with” here refers to that, a force is applied from outer surfaces of the first segment and the second segment of the second two-segment type crimping portion 222 of the second conductive terminal 220 toward inner surfaces of the first segment and the second segment of the second two-segment type crimping portion 222 of the second conductive terminal 220, so that the outer surfaces are depressed inwardly to retain the second conductor 511 and the second insulative layer 512 therein. In the present embodiment, the contacting portion of the first conductive terminal 130 and the contacting portion of the second conductive terminal 220 are electrically connected, and the tail portion 221 of the second conductive terminal 220 is crimped with the second conductive wire 510.

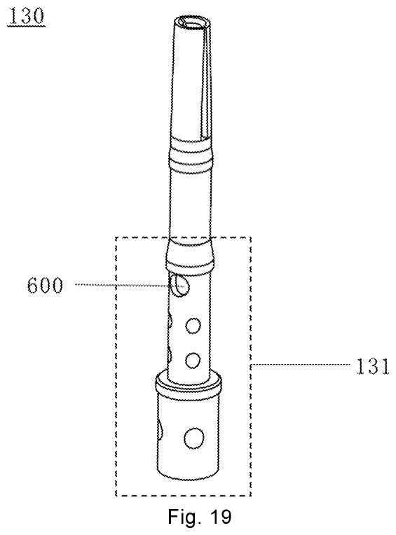

Continuously referring to FIG. 19, in some embodiments, a side wall of the first segment of the first two-segment type crimping portion 131 has an inspection hole 600 which penetrates the side wall, and/or, a side wall of the first segment of the second two-segment type crimping portion 222 has an inspection hole 600 (not shown) which penetrates the side wall. In the present embodiment, the provision of the inspection hole 600 facilitates inspection whether a position of the first conductor 411 of the first conductive wire 410 inserted into the first two-segment type crimping portion 131 is correct, and/or, facilitates inspection whether a position of the second conductor 511 of the second conductive wire 510 inserted into the second two-segment type crimping portion 222 is correct.

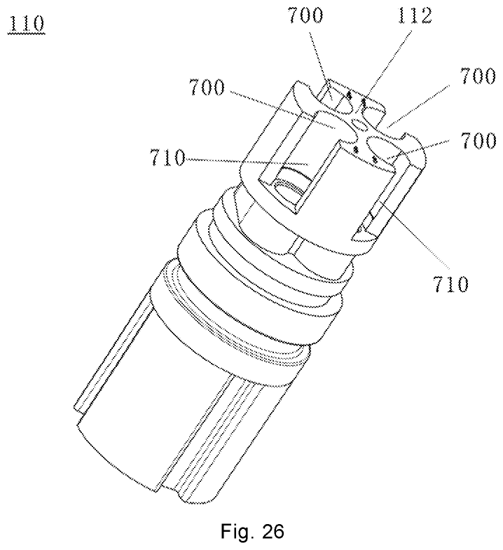

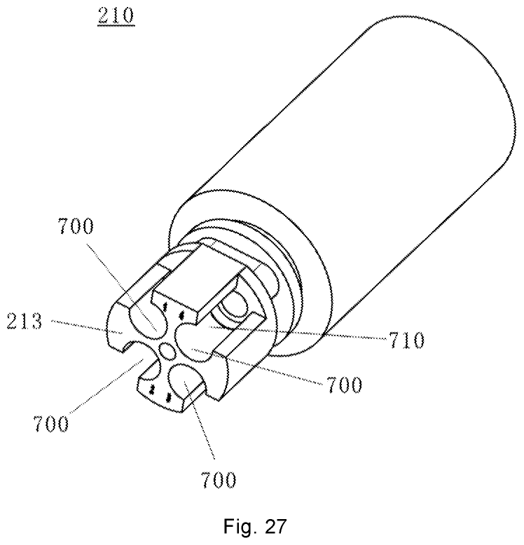

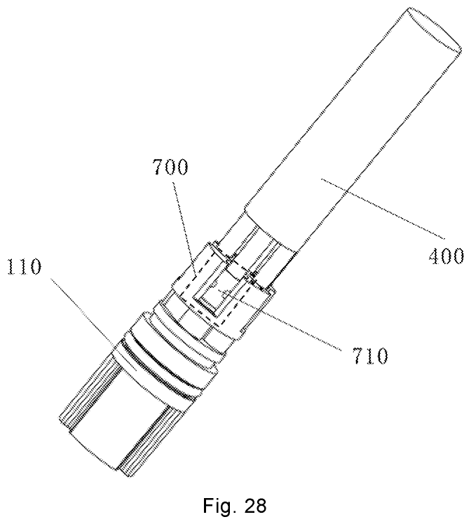

As shown in FIG. 26 to FIG. 28, in some embodiments, the first housing 110 has a bottom surface 112, is provided with a terminal connecting cavity 700, which is used to receive the first conductive terminal 130, from the bottom surface 112, a side wall of the terminal connecting cavity 700 has an opening 710; and/or, the third housing 210 has a rear surface 213, is provided with a terminal connecting cavity 700, which is used to receive the second conductive terminal 220, from the rear surface 213, a side wall of the terminal connecting cavity 700 has an opening 710. In some embodiments, the first housing 110 has a plurality of terminal connecting cavities 700 which are arranged along a circumferential direction of the first housing 110, each terminal connecting cavity 700 has the opening 710, the opening 710 is positioned on an outer periphery of the first housing 110. In other embodiments, the third housing 210 has a plurality of terminal connecting cavities 700 which are arranged along a circumferential direction of the third housing 210, each terminal connecting cavity 700 has an opening 710, the opening 710 is positioned on an outer periphery of the third housing 210. The provision of the opening 710 in the terminal connecting cavity 700 facilitates inspection whether the first conductive terminal 130 and/or the second conductive terminal 220 is mounted in place.

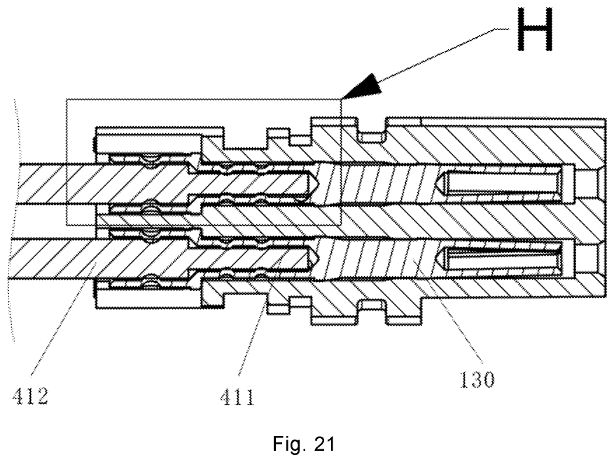

Continuously referring to FIG. 21, in some embodiments, one end of the first conductive terminal 130 close to the bottom surface 112 is positioned in the interior of the first housing 110, and is not coplanar with the bottom surface 112; and/or, one end of the second conductive terminal 220 close to the rear surface 213 is positioned in the interior of the third housing 210, and is not coplanar with the rear surface 213. In the present embodiment, the provision of the first conductive terminal 130 and/or the second conductive terminal 220 as described above assure the conductive terminals that the conductive terminals therebetween have sufficient creepage distance gap to pass the withstand voltage test.

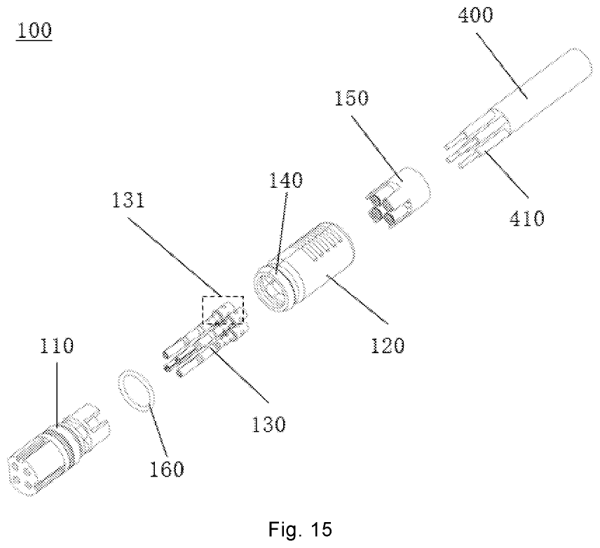

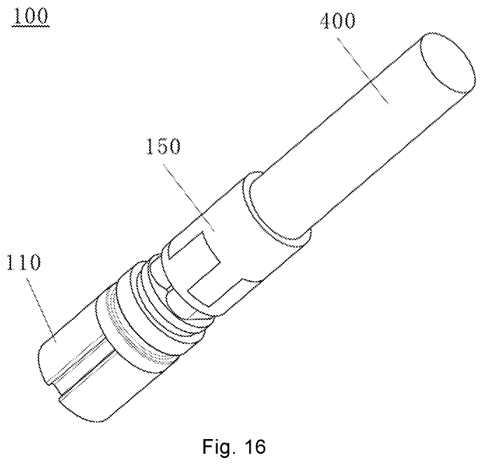

Continuously referring to FIG. 15 and FIG. 16, in some embodiments, the first electrical connector 100 further includes a fourth housing 150. The fourth housing 150 is sleeved over a connected position between the first conductive terminal 130 and the first conductive wire 410 to improve a retention force between the first conductive terminal 130 and the first conductive wire 410 and waterproof performance. In some embodiments, after the first conductive terminal 130 is crimped with the first conductive wire 410, overmolding may be performed at the connected position to form the fourth housing 150.

Continuously referring to FIG. 2 to FIG. 5 and FIG. 15, in some embodiments, the first electrical connector 100 further includes a sealing ring 160. The sealing ring 160 is sleeved over an outer surface of the first housing 110, which may effectively improve waterproof performance after the first electrical connector 100 and the second electrical connector 200 are mated with each other.

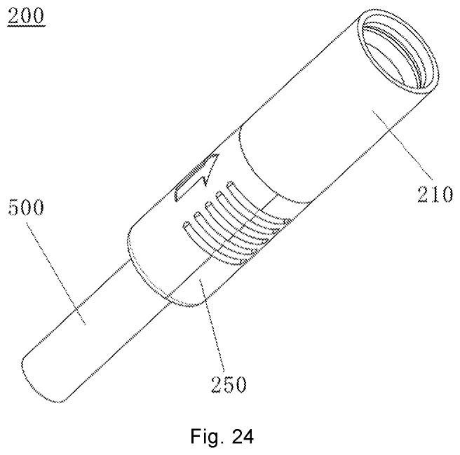

Continuously referring to FIG. 23 to FIG. 24, in some embodiments, the second electrical connector 200 further includes a fifth housing 240 and a sixth housing 250. The fifth housing 240 is sleeved over a connected position between the second conductive terminal 220 and the second conductive wire 510 to improve a retention force at the connected position between the second conductive terminal 220 and the second conductive wire 510 and waterproof performance. The sixth housing 250 is sleeved over the fifth housing 240 to further improve the retention force at the connected position between the second conductive terminal 220 and the second conductive wire 510 and waterproof performance, so that structure stability and waterproof performance of the second electrical connector 200 are improved.

Continuously referring to FIG. 6 to FIG. 8, in some embodiments, the second electrical connector 200 further includes a seal ring 260, and the seal ring 260 is sleeved over the third housing 210.

In conclusion, in the electrical connector assembly of the present disclosure, in a state the first electrical connector and the second electrical connector are mated with each other, the locking structure which is provided on the outer side surface of the one end of the second housing close to the first housing and is in form of protrusion resiliently snap-fits with the engaging structure which is provided on the inner side surface of the third housing and is in form of recessed groove, the locking structure of the first electrical connector may be received in the interior of the second electrical connector, in comparison with the latch structure provided on the outer surface of the electrical connector assembly in prior art, the overall size of the electrical connector assembly of the present disclosure is reduced, the electrical connectors which are small in dimension are realized in the present disclosure, diversity of application scenarios of the electrical connector assembly of the present disclosure is increased.

The above content is a further detailed description of the present disclosure in conjunction with specific selective implementations, and it cannot be affirmed that the specific implementations of the present disclosure are limited to these description. For ordinary technical personnel in the technical field to which the present disclosure belongs, without departing from the concept of the present disclosure, several simple deductions or substitutions can be made, and should be considered as belonging to the scope of protection of the present disclosure.

What is claimed is:

1. An electrical connector assembly, comprising:
a first electrical connector, the first electrical connector comprising a first housing, a second housing which surrounds an outer side of one end of the first housing, and a plurality of first conductive terminals which are positioned in an interior of the first housing and the second housing, an outer side surface of one end of the second housing close to the first housing having a locking structure which is in form of protrusion;
a second electrical connector, the second electrical connector comprising a third housing and a plurality of second conductive terminals which are positioned in an interior of the third housing, an inner side surface of the third housing having an engaging structure which is in form of recessed groove;
in a state that the first electrical connector and the second electrical connector are mated with each other, the second housing being partially inserted into the interior of the third housing, the locking structure resiliently snap-fitting with the engaging structure, the plurality of first conductive terminals and the plurality of second conductive terminals being electrically connected correspondingly.

2. The electrical connector assembly according to claim 1, wherein
an elasticity of the second housing is higher than an elasticity of the third housing;
the locking structure has a compressed state during a snap-fit engagement process between the locking structure and the engaging structure and a rebound state when the snap-fit engagement between the locking structure and the engaging structure is completed, thereby providing an operator with a tactile snap-fit sensation.

3. The electrical connector assembly according to claim 1, wherein
the locking structure is a conical annular protrusion which encircles the outer side surface of the second housing,
the engaging structure is a conical annular recessed groove which encircles the inner side surface of the third housing.

4. The electrical connector assembly according to claim 3, wherein
along a direction away from the first housing, the locking structure sequentially comprises a first inclined surface which is inclined toward an outer side of the second housing and an extending surface;
along a direction away from a mating surface of the second electrical connector, the engaging structure sequentially comprises a guiding surface, a second inclined surface which is inclined toward an outer side of the third housing, and a third inclined surface which is inclined toward an inner side of the third housing;
the first inclined surface and the extending surface therebetween form the conical protrusion which is inserted into the engaging structure, the second inclined surface and the third inclined surface therebetween form the conical recessed groove which receives the locking structure.

5. The electrical connector assembly according to claim 4, wherein
an angle of the conical protrusion is less than or equal to an angle of the conical recessed groove.

6. The electrical connector assembly according to claim 4, wherein
the first inclined surface and the extending surface of the locking structure therebetween further comprise a rounding surface which is arc, the rounding surface contacts the conical recessed groove of the engaging structure.

7. The electrical connector assembly according to claim 4, wherein
the extending surface is perpendicular to a mating direction that the first electrical connector is inserted into the second electrical connector.

8. The electrical connector assembly according to claim 4, wherein
an inner diameter of the third housing at the guiding surface is gradually decreased along a direction that the guiding surface is close to the second inclined surface, the guiding surface and the second inclined surface therebetween form a conical protruding portion, the conical protruding portion and the conical recessed groove of the engaging structure together cooperate with each other to latch with the locking structure.

9. The electrical connector assembly according to claim 1, wherein
an outer wall of the first housing has at least one first fool-proof portion,
an inner wall of the third housing has at least one second fool-proof portion,
in a state that the plurality of first conductive terminals and the plurality of second conductive terminals are electrically connected, the first fool-proof portion and the second fool-proof portion match each other.

10. The electrical connector assembly according to claim 1, wherein
an outer wall of the second housing has a first mount guiding structure,
an outer wall of the third housing has a second mount guiding structure,
in a state that the plurality of first conductive terminals and the plurality of second conductive terminals are electrically connected, the first mount guiding structure and the second mount guiding structure are aligned with each other.

11. The electrical connector assembly according to claim 1, wherein
tail portions of the plurality of second conductive terminals are arranged as a regular polygon.

12. The electrical connector assembly according to claim 1, wherein
the electrical connector assembly further comprises:
a first conductive wire group, the first conductive wire group comprises at least one first conductive wire, the first conductive wire comprises a first conductor and a first insulative layer which enwraps the first conductor;
each first conductive terminal has a first two-segment type crimping portion which is crimped with the corresponding first conductive wire, wherein a first segment of the first two-segment type crimping portion is crimped with the first conductor, a second segment of the first two-segment type crimping portion is crimped with the first insulative layer.

13. The electrical connector assembly according to claim 12, wherein
the electrical connector assembly further comprises:
a second conductive wire group, the second conductive wire group comprises at least one second conductive wire, the second conductive wire comprises a second conductor and a second insulative layer which enwraps the second conductor;
each second conductive terminal has a second two-segment type crimping portion which is crimped with the corresponding second conductive wire, wherein a first segment of the second two-segment type crimping portion is crimped with the second conductor, a second segment of the second two-segment type crimping portion is crimped with the second insulative layer.

14. The electrical connector assembly according to claim 13, wherein
a side wall of the first segment of the first two-segment type crimping portion has an inspection hole which penetrates the side wall; and/or
a side wall of the first segment of the second two-segment type crimping portion has an inspection hole which penetrates the side wall.

15. The electrical connector assembly according to claim 1, wherein
the first housing has a bottom surface, is provided with a terminal connecting cavity from the bottom surface, the terminal connecting cavity is used to receive the first conductive terminal, a side wall of the terminal connecting cavity has an opening; and/or
the third housing has a rear surface, is provided with a terminal connecting cavity from the rear surface, the terminal connecting cavity is used to receive the second conductive terminal, a side wall of the terminal connecting cavity has an opening.

16. The electrical connector assembly according to claim 15, wherein
one end of the first conductive terminal close to the bottom surface is positioned in the interior of the first housing and is not coplanar with the bottom surface; and/or
one end of the second conductive terminal close to the rear surface is positioned in the interior of the third housing and is not coplanar with the rear surface.
